(19) United States
(12) Patent Application Publication
(10) Pub. No.: US 2013/0015148 A1
(43) Pub. Date: Jan. 17, 2013

(54) Merchandise Strip with Support Member

(71) Applicant: Thomas E. Valiulis, Rockford, IL (US)

(72) Inventor: Thomas E. Valiulis, Rockford, IL (US)

(73) Assignee: Southern Imperial, Inc., Rockford, IL (US)

(21) Appl. No.: 13/183,527

(22) Filed: Jul. 15, 2011

(51) Int. Cl. A47F 1/04; B23P 11/00

(52) U.S. Cl. 211/59.2; 29/428

(57) ABSTRACT

A merchandise strip with a support member is provided. The merchandise strip includes a strip member and support member. The strip member is slidably received in the support member. The support member maintains the vertical and generally straight presentation of the strip member. The strip member is joined to the support member using a fastener.

### FIELD OF THE INVENTION

This invention generally relates to retail displays, and more particularly to merchandise strips.

### BACKGROUND OF THE INVENTION

Merchandise strips are generally known in the art. A merchandise strip is used in a retail environment to hang merchandise therefrom. Consumers can readily remove merchandise from the merchandise strip by pulling merchandise away from the same.

Merchandise strips are typically incorporated into retail structures such as shelving or other point of purchase displays. The strip mounts at an end thereof and freely hangs from the display.

With reference to FIG. 6, an exemplary embodiment of a known merchandise strip 10 is illustrated. The merchandise strip 10 is fastened to a retail structure 12 using a fastener such as pin 14. The strip includes a plurality of clips 18. Each clip includes tabs 22 and a hook 20. Merchandise 16 is loaded on the hooks 20.

Unfortunately, once loaded, there is a tendency for the strip 10 to exhibit an undesirable outward bow or lean as shown at FIG. 6 relative to reference axis 26. Such an outward bow or lean is caused by the spacing of the hooks 18 relative to the size of merchandise 16 carried thereon. More specifically, the hooks 20 are typically spaced a distance D from one another. Merchandise loaded on the hooks 20 has a length L which is greater than the distance D such that the items of merchandise 16 generally overlap one another, and are pushed outwardly and away from the merchandise strip 10.

As a result, the center of gravity G of each item of merchandise 16 is positioned outwardly from the strip 10, and more particularly the root of each hook 20, by a distance W as illustrated. As a result, the loading of each item of merchandise due to its own weight as illustrated by directional arrow 24 causes a moment M at the root of each hook 20. These moments M cause the aforementioned outward bow or lean.

This aforementioned outward lean is undesirable for several reasons. First, it is not aesthetically pleasing and generally tends to exhibit a generally disorganized look. Second, for heavier items, there is a risk that the outward bow or lean can be so pronounced that merchandise will fall off the hooks 20.

As such, there is a need in the art for a merchandise strip that eliminates or substantially reduces the aforementioned outward bow or lean. Embodiments of the invention provide such a merchandise strip. These and other advantages of the invention, as well additional inventive features, will be apparent from description of the embodiments of the invention provided herein.

### BRIEF SUMMARY OF THE INVENTION

In one aspect, a merchandise strip for carrying retail merchandise is provided. An embodiment of a merchandise strip according to this aspect includes a strip member having a mounting section and a strip section extending away from the mounting section. The strip section includes a plurality of clips and an aperture formed proximate an end thereof. The merchandise strip also includes a support member having a channel for receipt of the strip section. The support member includes an aperture formed proximate an end thereof within the channel. The strip member is slidably received by the channel such that the aperture of the strip member is aligned with the aperture of the support member. The merchandise strip also includes a fastener extending through the aperture of the strip member and through the support member for fastening the strip member to the support member.

In certain embodiments, the mounting section has a greater width than a width of the strip section. In certain embodiments, the mounting section defines a pair of abutments. An end of the support member abuts the abutments.

In certain embodiments, the width of the strip section is less than a width of the support member.

In certain embodiments, the support member is formed as a one piece extrusion. In certain embodiments, the support member is formed from a plastic material.

In certain embodiments, the channel includes an opening and a pair of grooves on either side of the opening. The support member also includes a backing wall, a pair of side walls in opposed spaced relation extending generally perpendicular to the backing wall, a first lip extending generally parallel with the backing wall and from an end of one of the pair of side walls, and a second lip extending generally parallel with the backing wall and from an end of the other one of the pair of side walls.

In certain embodiments, one of the pair of grooves is formed between the backing wall, one of the pair of side walls, and the first lip. The other one of the pair of grooves is formed between the backing wall, the other one of the pair of side walls, and the second lip.

In another aspect, a merchandise strip for carrying retail merchandise is provided. An embodiment of a merchandise strip according to this aspect includes a strip member having a plurality of clips for receipt of retail merchandise, with each clip including a hook and at least one tab. The merchandise strip also includes an extruded support member having a channel. The strip member is slidably received in the channel. The channel defines an opening and a pair of grooves positioned on either side of the opening. Each of the plurality of hooks extends through the opening of the channel. The merchandise strip also includes a fastener extending through the opening to fasten the strip member to the support member.

In certain embodiments, the opening has a first width, and the channel has a second width. The first width is less than the second width. The strip member includes a mounting section and a strip section. The strip section has a third width. The third width is greater than the first width and less than the second width. The mounting section has a forth width greater than the first, second, and third widths.

In certain embodiments, the strip member includes a flange portion disposed on either side of the plurality of hooks. The flange portion disposed on one side of the plurality of hooks is received in one of the pair of grooves. The flange portion on the other side of the plurality of hooks is received in the other one of the pair of grooves.

In another aspect, a method for assembling a retail display including a merchandise strip and a retail structure is provided. The merchandise strip has a strip member with a plurality of clips extending therefrom and a support member slidably receiving the strip member within a channel of support member. An embodiment of a method according to this aspect includes sliding the strip member into the channel of the support member. The method also includes fastening the strip member to the support member using a first fastener. The method also includes fastening the strip member and the support member to a retail structure using a second fastener.

In certain embodiments, the step of sliding the strip member into the channel includes positioning a pair of flange portions, respectfully, within a pair of grooves of the support member. The pair of grooves are positioned on either side of an opening of the channel. Each one of a plurality of hooks extends outwardly and through the opening.

In certain embodiments, the step of fastening the strip member to the support member includes aligning an aperture of the strip member with an aperture of the support member and passing a fastener therethrough. In certain embodiments, the step of fastening the strip member to the support member includes abutting an end of the support member with a pair of abutments of the strip member to align the aperture of the strip member with the aperture of the support member.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a merchandise strip according to the teachings of the present invention mounted on a retail structure;

FIG. 2 is an exploded perspective view of the merchandise strip of FIG. 1;

FIG. 3 is a cross-section of a support member of the merchandise strip of FIG. 1;

FIG. 4 is a cross-section of the support member of FIG. 3 and a strip member of the merchandise strip of FIG. 1;

FIG. 5 is a cross-section of the support member of FIG. 3 and strip member of FIG. 4 installed with a fastener to the retail structure of FIG. 1; and

FIG. 6 is a side view of a prior art merchandise strip.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

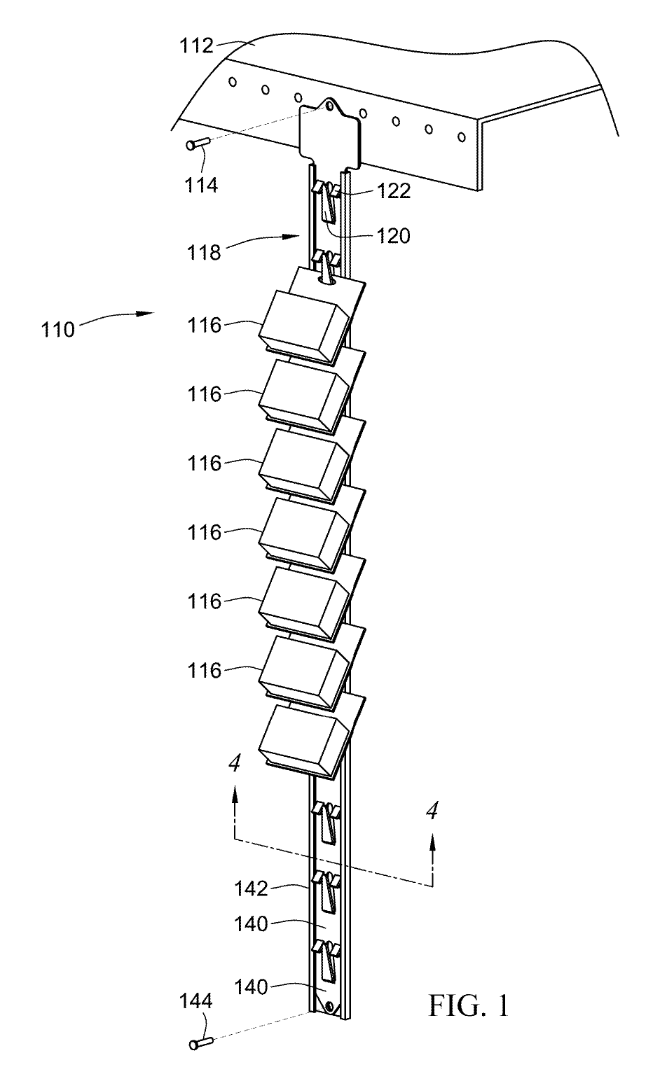

Turning now to the drawings, FIGS. 1-5 illustrate an embodiment of an improved merchandise strip 110 that overcomes the existing problems in the art. More specifically, the merchandise strip 110 described in greater detail below incorporates a support member that significantly reduces or entirely eliminates the undesirable outward bow of prior designs as described above and illustrated at FIG. 6. Thus, merchandise is carried by the merchandise strip 110 in an esthetically pleasing fashion and the tendency for merchandise to fall off the merchandise strip 110 is significantly reduced or eliminated.

With particular reference now to FIG. 1, the merchandise strip 110 is illustrated mounted on a retail structure 112 via a fastener such as pin 114. The merchandise strip 110 includes a plurality of clips 118 for the receipt of merchandise 116. Each clip 118 includes a hook 120 and tabs 122. As will be described in greater detail below, the merchandise strip 110 includes a strip member 140 slidably received and supported by a support member 142. The strip member 140 is attached to the support member 142 by way of a fastener such as pin 144.

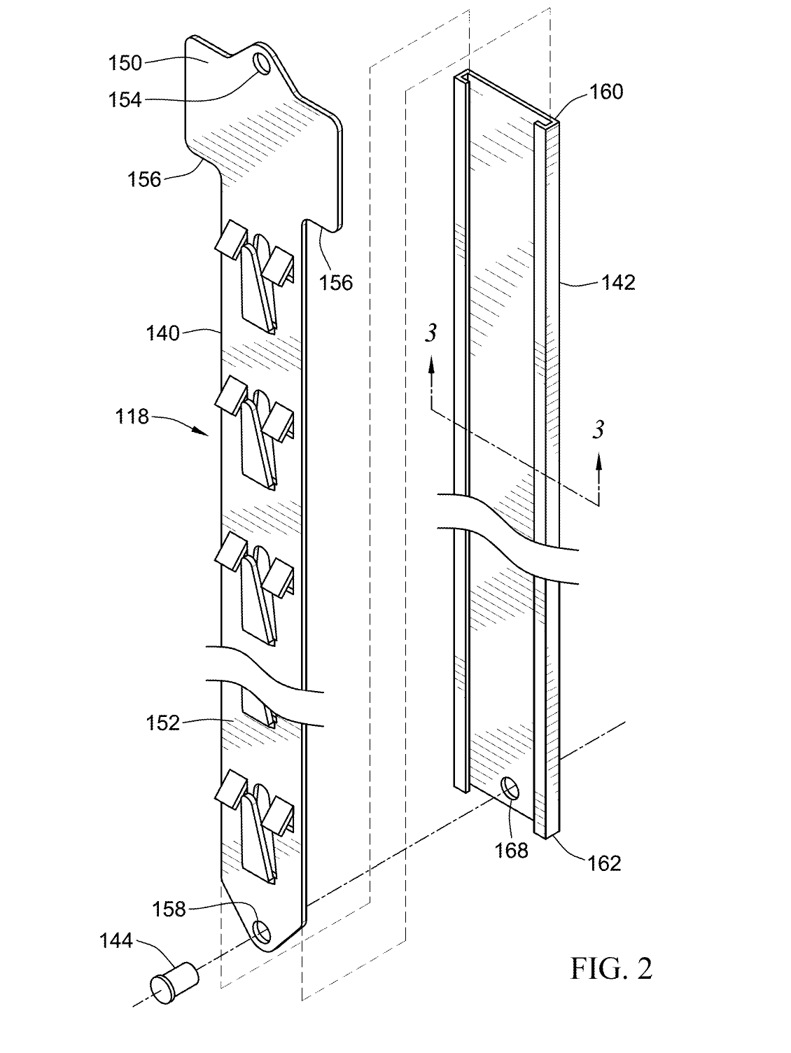

Turning now to FIG. 2, an assembly view of the merchandise strip 110 is illustrated. As shown, the strip member 140 slides into the support member 142. The strip member 140 includes a mounting section 150 and strip section 152. An aperture 154 is formed in the mounting section 150 for mounting the merchandise strip 110 to a retail structure 112 (See FIG. 1).

The mounting section 150 has a greater overall width than the strip section 152. As a result, the mounting section 150 also defines abutments 156 that serve as a positive stop to limit the upward sliding movement of the support member 142 relative to the strip member 140. The strip section 152 also includes an aperture 158 at an end thereof for receipt of the aforementioned pin 144.

The support member 142 has a first end 160 and a second end 162. The first end 160 abuts the abutments 156 of the strip member 140, and more particularly the mounting section 150 thereof, when the strip member 140 and support member 142 are fully assembled.

The second end 168 of the support member 142 includes an aperture 168 formed therethrough. The aperture 168 is alignable with the aperture 158 of the strip member 140 when these two components are assembled. As such, the pin 144 passes through both the aperture 158 of the strip member 140 as well as the aperture 168 of the support member 142.

The support member 142 functions to maintain the generally vertical and straight presentation of the strip member 140 when it is loaded with merchandise. As a result, the aforementioned outward bow of prior designs is reduced or eliminated. Additionally, the pin 144 holds the support member 142 in place relative to the strip member 140 such that the support member 142 does not slide away from the strip member 140 under gravity.

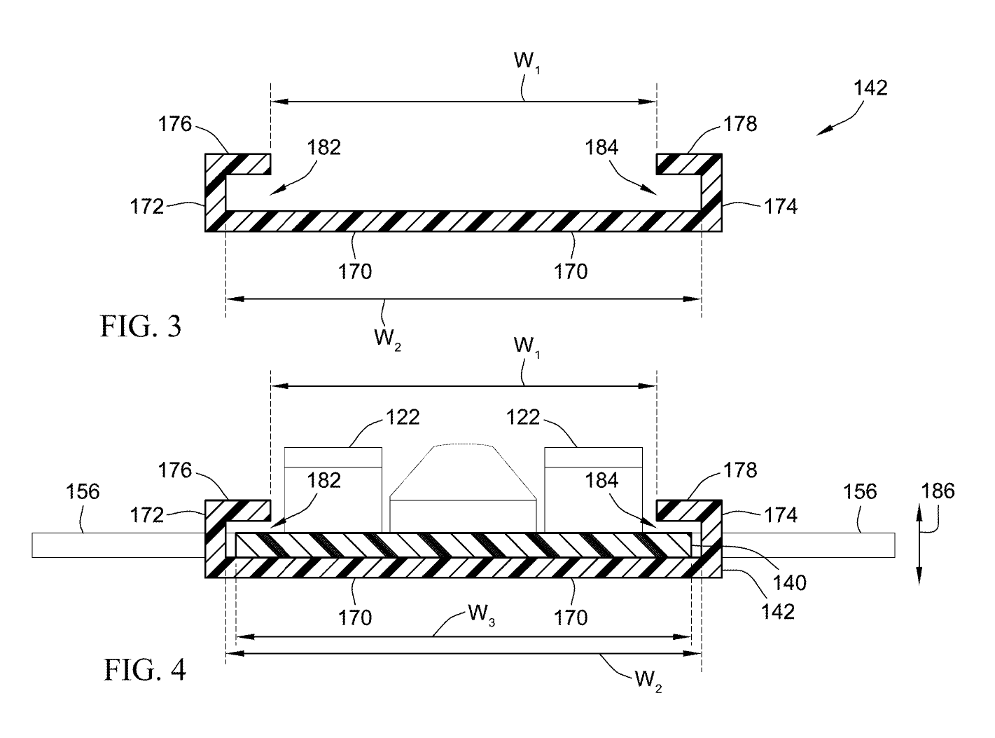

Turning now to FIGS. 3 and 4, the particular structural arrangement of the support member 142 and its interaction with the strip member 140 are explained in greater detail. With specific reference to FIG. 3, the support member 142 is shown in cross-section. The support member 142 includes a backing wall 170. A pair of side walls 172, 174 extend away from the backing wall 170 and at opposite ends thereof. A lip 176 that is generally parallel to the backing wall 170 extends from the left most side wall 172 illustrated in FIG. 3. A lip 178 extends generally parallel to the backing wall 170 from the other side wall 174 shown in FIG. 3. The lips 176, 178 terminate so as to define an opening having a width W₁.

Turning now to FIG. 4, the aforementioned opening forms a part of a channel 180 having grooves 182, 184 positioned at either side thereof The channel 180 has an overall width W₂. As can be deduced from FIG. 3, the overall width W₂ of the channel 180 is greater than the width W₁ of the opening.

The strip member 140 and support member 142 are shown in cross-section in an assembled state. The strip member 140 has an overall width W₃. This width W₃ is greater than the width W₁ of the opening but less than the width W₂ of the channel 180. As a result, the outer edges or flange portions of the strip member 140 extend into the grooves 182, 184 of the support member 142 as illustrated. Put differently, the lips 176, 178 extend inwardly and beyond the outer most edges of the support member 142. Such a configuration reduces or eliminates the ability for the strip member 140 to move in a direction parallel to axis 186 and relative to the support member 142. As a result, the above undesirable bow of prior designs is prevented.

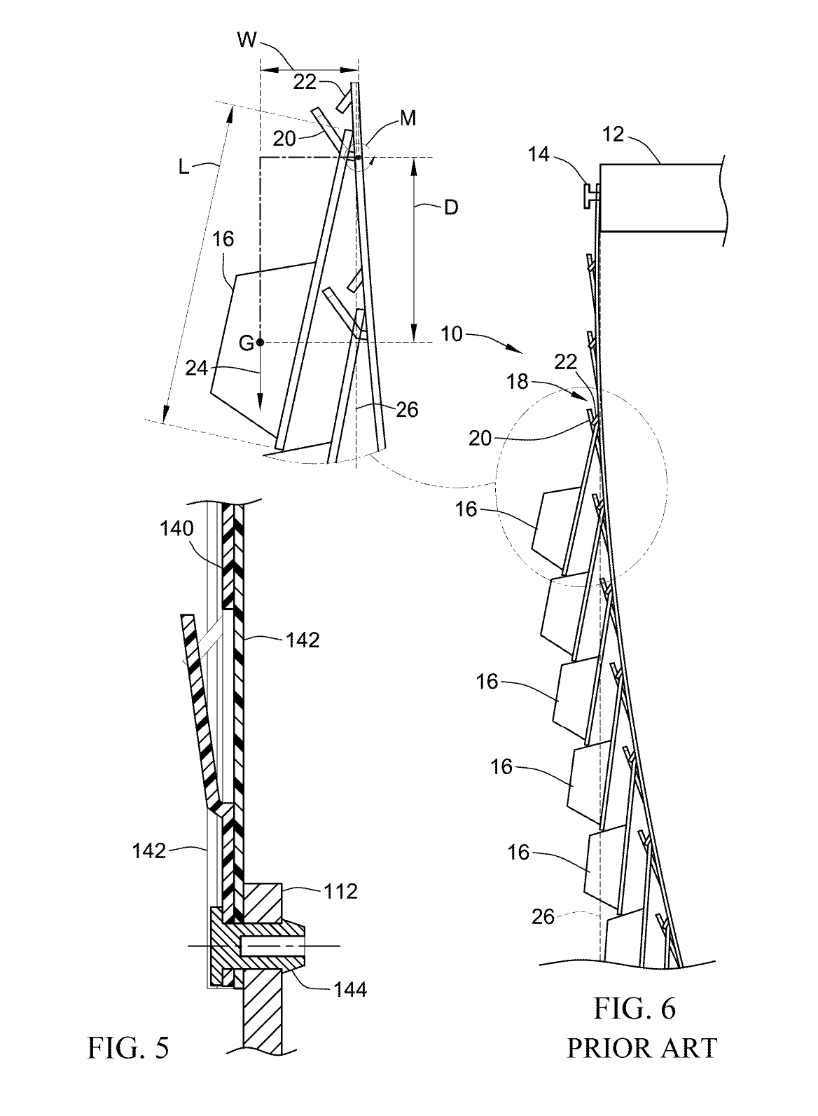

Turning now to FIG. 5, a cross-section of the strip member 140 and support member 142 in an assembled state is illustrated. Also shown at FIG. 5 is a portion of the retail structure 112 (See also FIG. 1). The pin 144, in the illustrated embodiment of FIG. 5, is long enough such that it not only joins the strip member 140 with the support member 142, but it also joins these components to the retail structure 112. As a result, the tendency for the merchandise strip 110 to swing or sway about pin 114 is to mount the mounting section 150 of the strip member 140 to the retail structure is reduced or eliminated. It will be recognized, however, that affixing both ends of the merchandise strip 110 is not necessary. Rather, the merchandise strip 110 can be mounted at its upper end as illustrated at FIG. 1, or at both ends as shown at FIGS. 1 and 5 when considered together.

The strip member 140 is preferably made of a plastic material using a molding process. The aperture 158 (See FIG. 2) therethrough may be made during molding or machined in a secondary step. Likewise, the support member 142 is also preferably made of a plastic material. The support member 142 can be manufactured as an extruded component. The aperture 168 (See FIG. 2) can be added in a subsequent machining step after extrusion. Additionally, the strip member 140, and support member 142 can be manufactured to various lengths to incorporate fewer or greater hooks 118 (See FIG. 1) depending on the ultimate application thereof.

Although illustrated as having a slidable support member 142, in other embodiments, the merchandise strip 110 can include a support member that attaches directly to a back of the strip member 140 without the need to slide the strip member 140 into the support member 142. Such a configuration increases the effective thickness of the merchandise strip 110, and thus reduces the above described bowing effect of prior designs. As another alternative, the strip member 140 can be molded with intermittent or continuous areas of increased thickness to reduce bowing. As an example of such an embodiment, one or more rails can be molded with the strip member 140 at the back surface of the strip member 140 to increase the rigidity of the strip member 140.

As described herein, the merchandise strip 110 advantageously overcomes existing problems and prior designs by incorporating a support member 142 which reduces or eliminates the tendency for a strip member 140 to otherwise have an outward bow when loaded with retail merchandise 116.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A merchandise strip for carrying retail merchandise thereon, comprising:
a strip member having a mounting section and a strip section extending away from the mounting section, the strip section including a plurality of clips and an aperture formed proximate an end thereof;
a support member having a channel for receipt of the strip section, the support member including an aperture formed proximate an end thereof within the channel, wherein the strip member is slidably received by the channel such that the aperture of the strip member is aligned with the aperture of the support member; and
a fastener extending through the aperture of the strip member and through the support member for fastening the strip member to the support member.

2. The merchandise strip of claim 1, wherein the mounting section has a greater with than a width of the strip section.

3. The merchandise strip of claim 2, wherein the mounting section defines a pair of abutments, wherein an end of the support member abuts the abutments.

4. The merchandise strip of claim 3, wherein the width of the strip section is less than a width of the support member.

5. The merchandise strip of claim 1, wherein the support member is formed as a one piece extrusion.

6. The merchandise strip of claim 5, wherein the support member is formed from a plastic material.

7. The merchandise strip of claim 1, wherein the channel includes an opening and a pair of grooves on either side of the opening.

8. The merchandise strip of claim 7, wherein the support member includes a backing wall, a pair of sidewalls in opposed spaced relation extending generally perpendicular to the backing wall, a first lip extending generally parallel with the backing wall and from an end of one of the pair of sidewalls, and a second lip extending generally parallel with the backing wall and from an end of the other one of the pair of sidewalls.

9. The merchandise strip of claim 8, wherein one of the pair of grooves is formed between the backing wall, one of the pair of sidewalls, and the first lip, and the other one of the pair of grooves is formed between the backing wall, the other one of the pair of sidewalls, and the second lip.

10. A merchandise strip for carrying retail merchandise, comprising:
a strip member including a plurality of clips for receipt of retail merchandise, each clip including a hook and at least one tab; and
an extruded support member including a channel, the strip member slidably received in the channel, the channel defining an opening and a pair of grooves positioned on either side of the opening, wherein each of the plurality of hooks extends through the opening of the channel; and
a fastener extending through the opening to fasten the strip member to the support member.

11. The merchandise strip of claim 10, wherein the opening has a first width, and the channel has a second width, the first width less than the second width.

12. The merchandise strip of claim 11, wherein the strip member includes a mounting section and a strip section, wherein the strip section has a third width.

13. The merchandise strip of claim 12, wherein the third width is greater than the first width and less than the second width.

14. The merchandise strip of claim 13, wherein the mounting section has a fourth width greater than the first, second, and third widths.

15. The merchandise strip of claim 10, wherein the strip member includes a flange portion disposed on either side of the plurality of hooks.

16. The merchandise strip of claim 15, wherein the flange portion disposed on one side of the plurality of hooks is received in one of the pair of grooves, and the flange portion on the other side of the plurality of hooks is received in the other one of the pair of grooves.

17. A method for assembling a retail display including a merchandise strip and a retail structure, the merchandise strip having a strip member with a plurality of clips extending therefrom and a support member slidably receiving the strip member within a channel of the support member, the method comprising:
sliding the strip member into the channel of the support member;
fastening the strip member to the support member using a first fastener; and
fastening the strip member and the support member to a retail structure using a second fastener.

18. The method of claim 17, wherein the step of sliding the strip member into the channel includes positioning a pair of flange portions, respectively, within a pair of grooves of the support member, the pair of grooves positioned on either side of an opening of the channel, such that each one of the plurality of hooks extends outwardly and through the opening.

19. The method of claim 17, wherein the step of fastening the strip member to the support member includes aligning an aperture of the strip member with an aperture of the support member and passing a fastener therethrough.

20. The method of claim 19, wherein the step of fastening the strip member to the support member includes abutting an end of the support member with a pair of abutments of the strip member to align the aperture of the strip member with the aperture of the support member.
